(19) United States
(12) Patent Application Publication
(10) Pub. No.: US 2014/0136925 A1
(43) Pub. Date: May 15, 2014

(54) METHOD OF OPERATING A DATA STORAGE DEVICE

(71) Applicant: SK hynix Inc., Icheon-si (KR)

(72) Inventor: Seok Jin JOO, Icheon-si (KR)

(21) Appl. No.: 13/944,753

(22) Filed: Jul. 17, 2013

(30) Foreign Application Priority Data
Nov. 14, 2012 (KR) 10-2012-0128940

(51) Int. Cl. G06F 11/10

(52) U.S. Cl. CPC G06F 11/1068
USPC 714/764

(57) ABSTRACT

A method of operating a data storage device including a nonvolatile memory device includes reading last programmed data from the nonvolatile memory device, detecting an error included in the data read in the reading, correcting the error of if the error is correctable, and reprogramming the corrected data to the nonvolatile memory device.

### CROSS-REFERENCES TO RELATED APPLICATION

The present application claims priority under 35 U.S.C. §119(a) to Korean application number 10-2012-0128940, filed on Nov. 14, 2012, in the Korean Intellectual Property Office, which is incorporated herein by reference in its entirety.

### BACKGROUND

1. Technical Field

The present invention relates to a data storage device, and more particularly, to a method of operating the data storage device to improve the reliability thereof.

2. Related Art

Computing has become ubiquitous so that computer systems can be used essentially anytime and anywhere. Because of this, the use of portable electronic devices such as mobile phones, digital cameras, and notebook computers has rapidly increased. In general, such portable electronic devices use a data storage device which uses a memory device. The data storage device may be used as a main memory device or an auxiliary memory device of a portable electronic device.

A data storage device using a memory device provides advantages at least because there is no mechanical driving part. As a result, stability and durability are excellent, information access speed is high and power consumption is low. Data storage devices having such advantages include a USB (universal serial bus) memory device, a memory card having various interfaces, and a solid state drive (SSD).

Data write-requested from a host is stored in a memory device of a data storage device. In some instances, the power supply may be suddenly interrupted while data is stored in the memory device. That is to say, a sudden power-off may occur in the data storage device while the data write-requested from the host is stored in the memory device. If the sudden power-off occurs while the data is stored in the memory device, the data may be corrupted. If the corrupted data is corrected by an error correction unit of the data storage device, the data storage device may operate normally. However, if the corrupted data is not corrected, the data storage device may provide wrong data to the host or may cause a read fail.

The data storage device may perform an error detection and correction algorithm to remove errors included in the data caused, for example, by sudden power-off while the data is stored in the memory device. For example, the data storage device may perform the error detection and correction algorithm when a booting operation is performed.

### SUMMARY

An operating method of a data storage device for improving the reliability of the data storage device is described herein.

One implementation is a method of operating a data storage device including a nonvolatile memory device, the method including reading last programmed data from the nonvolatile memory device, detecting an error in the read data, determining whether the error is correctable, correcting the error in the read data to generate corrected data if the error detected from the read data is correctable, and reprogramming the corrected data to the nonvolatile memory device.

Another implementation is a method of operating a data storage device including a nonvolatile memory device, the method including reading last programmed data from the nonvolatile memory device according to a first reference read voltage, detecting a first error in the data read according to the first reference read voltage, determining whether the first error is uncorrectable, reading the last programmed data from the nonvolatile memory device according to a second reference read voltage if the first error is uncorrectable, detecting a second error in the data read according to the second reference read voltage, determining whether the second error is correctable, correcting the second error to generate corrected data if the second error is correctable, and reprogramming the corrected data to the nonvolatile memory device.

Another implementation is a method of operating a data storage device including a nonvolatile memory device, the method including reading last programmed data from the nonvolatile memory device according to a first reference read voltage, detecting a first error in the data read according to the first reference read voltage, determining whether the first error is correctable, comparing the number of error bits of the data read according to the first reference read voltage with a reference number of bits, if the first error is correctable, correcting the first error to generate corrected data if the number of error bits of the data read according to the first reference read voltage is greater than the reference number of bits, and reprogramming the corrected data to the nonvolatile memory device.

### BRIEF DESCRIPTION OF THE DRAWINGS

Features, aspects, and embodiments are described in conjunction with the attached drawings, in which:

FIG. 1 is a block diagram exemplarily showing a data processing system including a data storage device in accordance with an embodiment;

FIG. 2 is a threshold voltage distribution graph of memory cells, explaining a fail mechanism of the data storage device in the case where a sudden power-off occurs;

FIG. 3 is a flow chart explaining an operating method of a data storage device in accordance with a first embodiment;

FIG. 4 is an exemplary threshold voltage distribution graph of multi-level cells each capable of storing multi-bit data;

FIG. 5 is a flow chart explaining an operating method of a data storage device in accordance with a second embodiment;

FIG. 6 is a threshold voltage distribution graph explaining an operating method of a data storage device in accordance with a third embodiment;

FIG. 7 is a flow chart explaining the operating method of a data storage device in accordance with the third embodiment;

FIG. 8 is a block diagram explaining a control relationship between a controller and a memory device of the data storage device in accordance with some embodiments;

FIG. 9 is a graph explaining the number of error bits according to a read voltage level of the memory device in accordance with some embodiments;

FIG. 10 is a first flow chart explaining an operating method of a data storage device in accordance with another embodiment;

FIG. 11 is a second flow chart explaining the operating method of a data storage device in accordance with some embodiments;

FIG. 12 is a first flow chart explaining an operating method of a data storage device in accordance with another embodiment;

FIG. 13 is a second flow chart explaining the operating method of a data storage device in accordance with the embodiment of FIG. 12;

FIG. 14 is a block diagram exemplarily showing a data processing system in accordance with another embodiment;

FIG. 15 is a diagram exemplarily showing a memory card in accordance with an embodiment;

FIG. 16 is a block diagram showing the internal configuration of the memory card shown in FIG. 15 and the connection relationship between the memory card and a host;

FIG. 17 is a block diagram showing an SSD in accordance with an embodiment;

FIG. 18 is a block diagram exemplarily showing the SSD controller shown in FIG. 17; and

FIG. 19 is a block diagram exemplarily showing a computer system in which a data storage device in accordance with an embodiment is mounted.

### DETAILED DESCRIPTION

In the description of the exemplary embodiments that follows, various advantages, features and methods are outlined with reference to the drawings. The present invention may, however, be embodied in different forms and should not be construed as being limited to the embodiments set forth herein.

It is to be understood herein that embodiments of the present invention are not limited to the particulars shown in the drawings and that the drawings are not necessarily to scale and in some instances proportions may have been exaggerated in order to more clearly depict certain features of the invention. While particular terminology is used herein, it is to be appreciated that the terminology used herein is for the purpose of describing particular embodiments only and is not intended to limit the scope of the present invention.

As used herein, the term “and/or” includes any and all combinations of one or more of the associated listed items. It will be understood that when an element is referred to as being “on,” “connected to” or “coupled to” another element, it may be directly on, connected or coupled to the other element or intervening elements may be present. As used herein, a singular form is intended to include plural forms as well, unless the context clearly indicates otherwise. It will be further understood that the terms “includes” and/or “including,” when used in this specification, specify the presence of at least one stated feature, step, operation, and/or element, but do not preclude the presence or addition of one or more other features, steps, operations, and/or elements thereof.

Hereinafter, a method of operating a data storage device is described below with reference to the accompanying drawings illustrating exemplary embodiments.

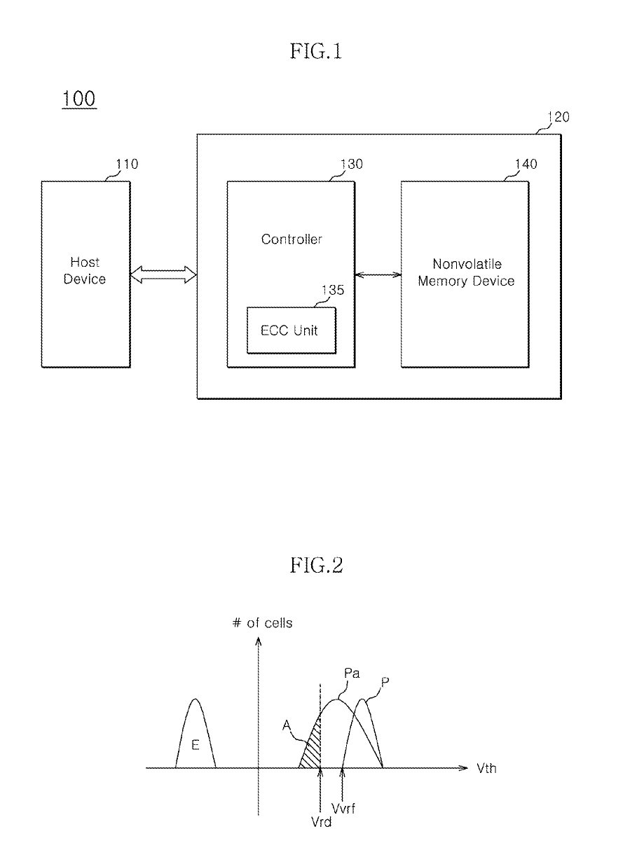

FIG. 1 is a block diagram exemplarily showing a data processing system including a data storage device in accordance with an embodiment. FIG. 2 is a threshold voltage distribution graph of memory cells, illustrating a fail mechanism of the data storage device in the case where a sudden power-off occurs. Referring to FIG. 1, a data processing system 100 includes a host device 110 and a data storage device 120.

The host device 110 includes, for example, a portable electronic device such as a mobile phone, an MP3 player, and so forth, or an electronic device such as a laptop computer, a desktop computer, a game machine, a TV, a beam projector, and so forth.

The data storage device 120 is configured to operate in response to a request from the host device 110. The data storage device 120 is configured to, for example, store data processed by the host device 110. In other words, the data storage device 120 may be used as a main memory device or an auxiliary memory device of the host device 110.

The data storage device 120 includes a controller 130 and a nonvolatile memory device 140. The controller 130 and the nonvolatile memory device 140 may be part of a memory card which is connected with the host device 110 through an interface. Alternatively, the controller 130 and the nonvolatile memory device 140 may be part of a solid state drive (SSD).

The controller 130 may be configured to control the nonvolatile memory device 140 in response to a request from the host device 110. For example, the controller 130 may be configured to provide the data read from the nonvolatile memory device 140, to the host device 110. As another example, the controller 130 may be configured to store the data provided from the host device 110, to the memory device 140. For this operation, the controller 130 is configured to drive a firmware.

For instance, the nonvolatile memory device 140 may be a NAND flash memory device. However, it will be appreciated that the nonvolatile memory device 140 may be another type of nonvolatile memory device. For example, the nonvolatile memory device 140 may be any of various nonvolatile memory devices such as a NOR flash memory device, a ferroelectric RAM (FRAM) using ferroelectric capacitors, a magnetic RAM (MRAM) using a tunneling magneto-resistive (TMR) layer, a phase change memory device (PRAM) using a chalcogenide alloy, and a resistive memory device (RERAM) using a transition metal oxide.

The nonvolatile memory device 140 includes a plurality of memory cells. Each of the memory cells may store 1-bit data or 2 or more-bit data. A memory cell capable of storing 1-bit data is referred to as a single level cell (SLC). The single level cell (SLC) is programmed to have a threshold voltage which corresponds to an erased state and one programmed state. A memory cell capable of storing 2 or more-bit data is referred to as a multi-level cell (MLC). The multi-level cell (MLC) is programmed to have a threshold voltage which corresponds to an erased state and any one of a plurality of programmed states.

The nonvolatile memory device 140 performs a read or program operation by pages due to a structural characteristic of the memory device 140. Further, the nonvolatile memory device 140 performs an erase operation by blocks due to a structural characteristic of the memory device 140. A page includes a plurality of memory cells, and a block includes a plurality of pages.

If a power supply is interrupted while the data provided from the host device 110 are stored in the nonvolatile memory device 140, that is, a power-off occurs, the data may not be appropriately stored. FIG. 2 shows a threshold voltage distribution P of memory cells of the nonvolatile memory device 140 in the case where data are normally stored, and a threshold voltage distribution Pa of memory cells of the nonvolatile memory device 140 in the case where data are abnormally stored due to, for example, the sudden power-off.

As can be seen from FIG. 2, in the case where data are abnormally stored, the threshold voltages of the memory cells may have values in a region A, which is lower than a read voltage Vrd. Accordingly, if data are abnormally stored, the retention of the nonvolatile memory device 140 is degraded, and, in some instances, the number of memory cells having threshold voltages in the region A may be unsatisfactorily large. The data stored in the memory cells of which threshold voltages are in the region A are recognized as including errors. While no problem is caused if the errors are corrected by an ECC (error correction code) unit 135, a read fail may occur in the data storage device 120 if the errors are not corrected.

For instance, a number of errors capable of being corrected may be included in the data of the memory cells. If the number of the memory cells of which threshold voltages are in the region A increases due to the degradation of the retention characteristic, a number of errors incapable of being corrected may be included in the data of such memory cells. Accordingly, the errors occurring due to the interruption of the program operation may be initially correctable, but with additional time, it may become impossible to correct all of the errors. According to some embodiments, in order to mitigate this problem, once a normal power state is restored, an error detection and correction operation is performed for data which a program operation has been most recently performed. The operation may be performed, for example, when a booting operation is performed).

According to some embodiments, the controller 130 performs the error detection and correction operation or operations. Such error detection and correction is performed through the ECC unit 135. The controller 130 may perform the error detection and correction for data which were programmed last, when the booting operation for the data storage device 120 is performed. In the case where the error detection and correction has failed, because the errors included in the data last programming operation cannot be corrected, the controller 130 receives the same data from the host device 110 and reprograms the received data. In the case where the error detection and correction operation succeeds, the errors included in the data last programmed can be corrected. However, since additional errors may occur as described above, the controller 130 corrects the errors of the data last programmed and reprograms the error-corrected data. The error detection and correction of the controller 130 is described in detail through the following embodiments.

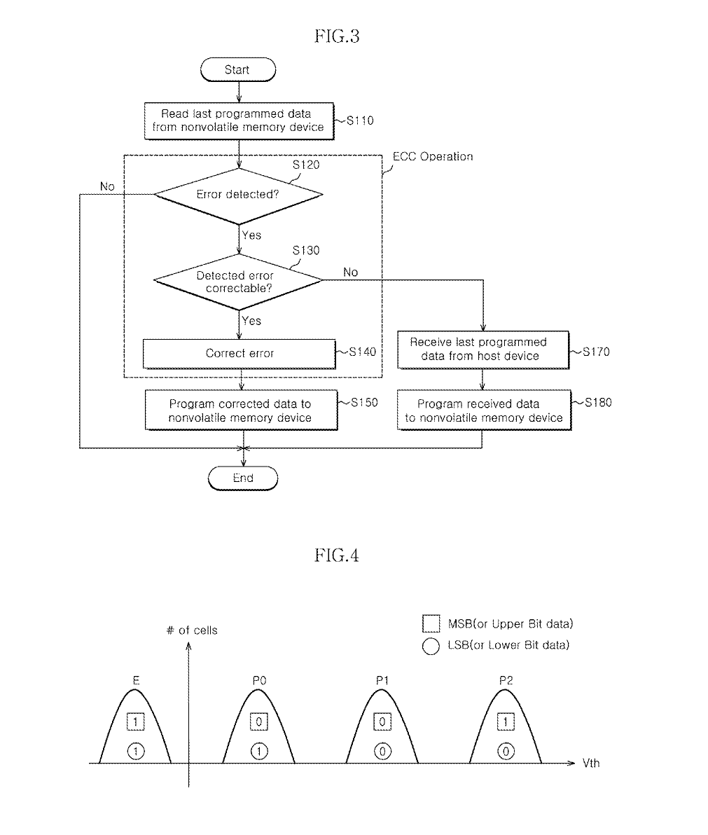

FIG. 3 is a flow chart illustrating a method of operating a data storage device in accordance with a first embodiment. In FIG. 3, a series of ECC operations are shown. The operations determine whether a detected error is correctable or not and correct correctable errors. The operations also replace data having uncorrectable errors. As discussed above, reprogram operations are performed in the case where the ECC operation for last programmed data has failed and, in some embodiments, in the case where the ECC operation has passed.

In step S110, during a booting operation, the controller 130 (see FIG. 1) reads the last or most recently programmed data from the nonvolatile memory device 140 (see FIG. 1). As described above, the nonvolatile memory device 140 performs the read operation in pages. The read data may be stored in one or more pages.

In step S120, the ECC unit 135 (see FIG. 1) detects whether the read most recently stored data includes an error. For example, an error detecting operation of the ECC unit 135 may be performed using parity data. If no error is detected in the last programmed data, the procedure ends. Conversely, if an error is detected in the last programmed data, the procedure proceeds to step S130.

In step S130, the ECC unit 135 determines whether the error included in the read data, that is, the last programmed data, is correctable. If the error is correctable, the procedure proceeds to step S140. Conversely, if it is determined that the error is uncorrectable, the procedure proceeds to step S170.

In step S140, the ECC unit 135 corrects the error included in the last programmed data according to a correction algorithm.

In step S150, the controller 130 reprograms the error-corrected data to the nonvolatile memory device 140. For example, the error-corrected data may be reprogrammed to an area where it was originally stored (for example, an area where the last programmed data was stored). In some embodiments, the error-corrected data is reprogrammed to an area different from the area where it was originally stored (for example, an area different from the area where the last programmed data was stored). Once the error-corrected data is programmed to the nonvolatile memory device 140, the controller 130 ends the reprogram operation.

If the error included in the last programmed data is uncorrectable, the procedure proceeds from step S130 to step S170. In step S170, the controller 130 receives the last programmed data from the host device 110 (see FIG. 1). In step S180, the controller 130 programs the received data to the nonvolatile memory device 140. Once the received data is programmed to the nonvolatile memory device 140, the controller 130 ends the reprogram operation.

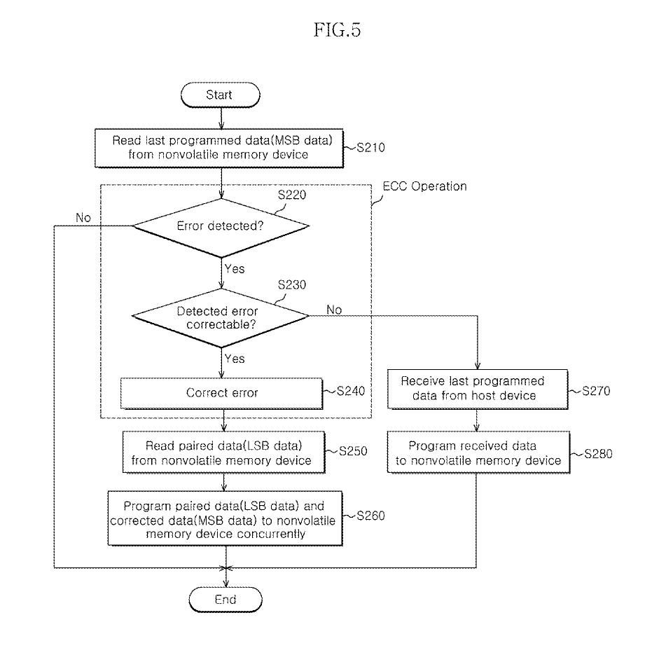

FIG. 4 illustrates an exemplary threshold voltage distribution graph of multi-level cells each capable of storing multi-bit data. As described above, each of the plurality of memory cells included in the nonvolatile memory device 140 (see FIG. 1) may store 1-bit data or 2 or more-bit data. A memory cell capable of storing 2 or more-bit data is referred to as a multi-level cell (MLC). FIG. 4 illustrates an exemplary threshold voltage distribution graph of MLCs which can store 2-bit data.

A 2-bit multi-level cell (MLC) is programmed to have a threshold voltage corresponding to an erased state E or any one of a plurality of programmed states P0 to P2 according to lower bit data and upper bit data. The lower bit data is referred to as LSB (least significant bit) data, and the upper bit data is referred to as MSB (most significant bit) data.

The multi-level cell MLC may be programmed in a sequential program scheme such that the upper bit data (MSB data) is programmed after the lower bit data (LSB data) is programmed. In some embodiments, the multi-level cell MLC may be programmed in a one shot program scheme or a write once program scheme such that the lower bit data (LSB data) and the upper bit data (MSB data) are concurrently programmed.

No matter in which scheme the multi-level cell MLC is programmed, the multi-level cell MLC is programmed to have a threshold voltage distribution according to the pair of data, that is, the combination of the lower bit data (LSB data) and the upper bit data (MSB data). According to an embodiment, if programming is interrupted, for example, when a sudden power-off occurs, and the last programmed data is upper bit data (MSB data), the controller 130 (see FIG. 1) may reprogram both the upper bit data (MSB data) and the corresponding lower bit data (LSB data). Such a reprogram method is described below with reference to FIG. 5.

FIG. 5 is a flow chart illustrating a method of operating a data storage device in accordance with a second embodiment. In FIG. 5, a series of operations are shown. The operations determine whether a detected error is correctable or not and correct correctable errors. The operations also replace data having uncorrectable errors. As discussed above, reprogram operations are performed in the case where the ECC operation for last programmed data has failed and, in some embodiments, in the case where the ECC operation has passed.

In step S210, during a booting operation, the controller 130 (see FIG. 1) reads the last or most recently programmed data, for example, upper bit data (MSB data), from the nonvolatile memory device 140 (see FIG. 1).

In step S220, the ECC unit 135 (see FIG. 1) detects whether the read most recently programmed data includes an error. For example, an error detecting operation of the ECC unit 135 may be performed using parity data. If no error is detected in the last programmed data, the procedure ends. Conversely, if an error is detected in the last programmed data, the procedure proceeds to step S230.

In step S230, the ECC unit 135 determines whether the error included in the read data, that is, the last programmed data, is correctable. If the error is correctable, the procedure proceeds to step S240. Conversely, if the error is uncorrectable, the procedure proceeds to step S270.

In step S240, the ECC unit 135 corrects the error included in the last programmed data according to a correction algorithm.

In step S250, the controller 130 determines that the last programmed data is upper bit data (MSB data) and reads the LSB data paired with the MSB data from the nonvolatile memory device 140.

In step S260, the controller 130 reprograms both the paired data (LSB data) and the error-corrected data (MSB data) to the nonvolatile memory device 140. For example, the paired data (LSB data) and the error-corrected data (MSB data) may be reprogrammed to areas where they were originally stored (for example, an area where the paired data was stored and an area where the last programmed data was stored). In some embodiments, the paired data (LSB data) and the error-corrected data (MSB data) may be reprogrammed to areas different from the areas where they were originally stored (for example, areas other than the area where the paired data was stored and the area where the last programmed data was stored). Once the paired data (LSB data) and the error-corrected data (MSB data) are programmed to the nonvolatile memory device 140, the controller 130 ends the reprogram operation.

If the error included in the last programmed data is uncorrectable, the procedure proceeds from step S230 to step S270. In step S270, the controller 130 receives the last programmed data from the host device 110 (see FIG. 1).

In some embodiments, the controller 130 determines that the last programmed data is upper bit data (MSB data) and either receives the LSB data paired with the MSB data from the nonvolatile memory device 140 or receives the paired LSB data from the host device 110 in addition to the last programmed MSB data.

In step S280, the controller 130 programs the received data to the nonvolatile memory device 140. Once the received data is normally programmed to the nonvolatile memory device 140, the controller 130 ends the reprogram operation.

According to the method of FIG. 5, if a correctable error is included in last programmed data, the error is corrected, and the error-corrected data and paired data of such data are concurrently reprogrammed. As a consequence, both of a pair of data (for example, lower bit data and upper bit data) can be reprogrammed.

In addition, if an uncorrectable error is included in the last programmed data, the last data is received from the host device for reprogramming. Furthermore, data paired with the last programmed data can be received from either the nonvolatile memory device 140 or the host device for programming with last programmed data.

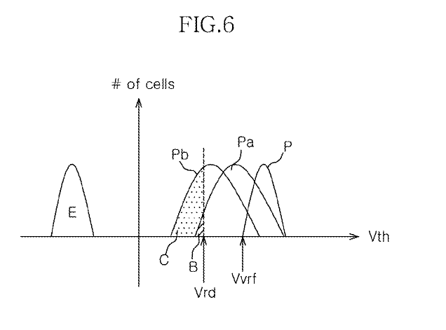

FIG. 6 is a threshold voltage distribution graph illustrating an operating method for a data storage device in accordance with a third embodiment. FIG. 6 shows a threshold voltage distribution P of memory cells of the nonvolatile memory device 140 (see FIG. 1) in the case where data are normally stored. FIG. 6 also shows threshold voltage distributions Pa and Pb of memory cells of the nonvolatile memory device 140 in the case where data are abnormally stored due to, for example, a sudden power-off. The threshold voltage distribution Pa is closer to the normal threshold voltage distribution P than the threshold voltage distribution Pb. Accordingly, it may be inferred that the program operation for the memory cells forming the threshold voltage distribution Pb was interrupted earlier in the program operation than the program operation for the memory cells forming the threshold voltage distribution Pa.

Data stored in the memory cells having threshold values in regions B and C include errors. The data stored in the memory cells having the threshold voltage distribution Pa include fewer errors than the data stored in the memory cells having the threshold voltage distribution Pb.

For instance, since the threshold voltage distribution Pa is closer to the normal threshold voltage distribution P than distribution Pb, the data stored in the memory cells having the threshold voltage distribution Pa may include a number of correctable errors. Even if the memory cells having threshold voltages in the region B have a poor retention characteristic, the data stored these memory cells may still include a number of correctable errors.

Conversely, since the threshold voltage distribution Pb is farther from the threshold voltage distribution P, the data stored in the memory cells having the threshold voltage distribution Pb may include a number of uncorrectable errors. Even though the memory cells having the threshold voltage distribution Pb may include a number of correctable errors, these memory cells may also include a number of uncorrectable errors.

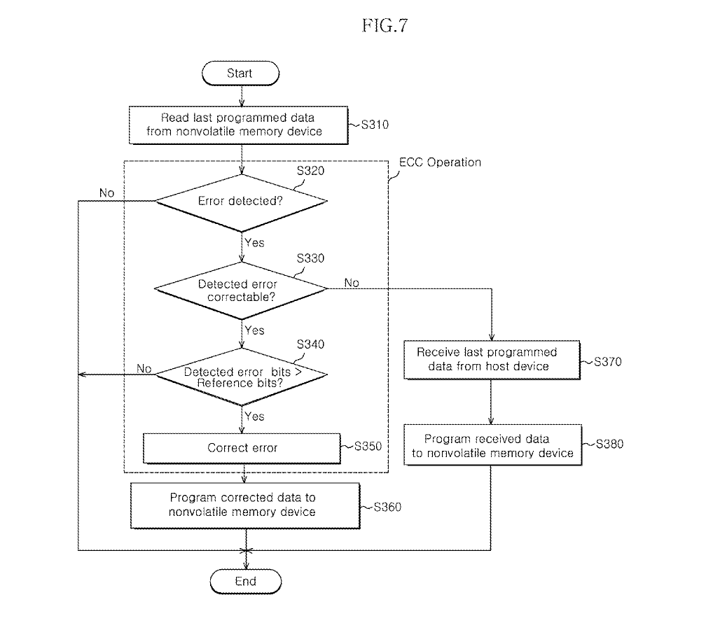

Accordingly, while the errors occurred, for example, due to an interruption of a program operation, are initially correctable, they may become uncorrectable as a time lapses (for example, as the retention characteristic is degraded). According to an embodiment, in the case where an ECC operation for last programmed data is passed, that is, in the case where a correctable number of errors are included in last programmed data, the controller 130 (see FIG. 1) may selectively perform a reprogram operation according to the number of error bits. Such a reprogram method is described below with reference to FIG. 7.

FIG. 7 is a flow chart explaining the operating method of a data storage device in accordance with a third embodiment. In FIG. 7, a series of operations are shown. The operations determine whether a detected error is correctable or not and correct correctable errors. The operations also replace data having uncorrectable errors. As discussed above, reprogram operations are performed in the case where the ECC operation for last programmed data has failed and, in some embodiments, in the case where the ECC operation has passed.

In step S310, during a booting operation, the controller 130 (see FIG. 1) reads the last or most recently programmed data from the nonvolatile memory device 140 (see FIG. 1).

In step S320, the ECC unit 135 (see FIG. 1) detects whether the read most recently programmed data includes an error. For example, an error detecting operation of the ECC unit 135 may be performed using parity data. If no error is detected in the last programmed data, the procedure ends. Conversely, if an error is detected in the last programmed data, the procedure proceeds to step S330.

In step S330, the ECC unit 135 determines whether the error in the read data, that is, the last programmed data, is correctable. If the error is correctable, the procedure proceeds to step S340. Conversely, if the error is uncorrectable, the procedure proceeds to step S370.

In step S340, the ECC unit 135 determines whether the number of error bits included in the read data, that is, the last programmed data, is greater than a reference number of bits. The reference has a value less than a maximum number of correctable error bits. According to the number of error bits in the read data, the reprogram operation is selectively performed. If the number of error bits is less than the reference value, since the probability of an uncorrectable error is small, the reprogram procedure is ended. Conversely, if the number of error bits is greater than the reference value, since the probability of an uncorrectable error is large, the procedure proceeds to step S350.

In step S350, the ECC unit 135 corrects the error included in the last programmed data according to a correction algorithm.

In step S360, the controller 130 reprograms error-corrected data to the nonvolatile memory device 140. For instance, the error-corrected data may be reprogrammed to an area where it was originally stored (for example, an area where the last programmed data was stored). In some embodiments, the error-corrected data may be reprogrammed to an area different from the area where it was originally stored (for example, an area different from the area where the last programmed data was stored). In another example, while not shown in the drawing, as described above with reference to the method of FIG. 5, in the case where the last programmed data is upper bit data (MSB data), the controller 130 may read paired data (LSB data) and reprogram the paired data (LSB data) and the error-corrected data (MSB data) to the nonvolatile memory device 140. When the error-corrected data is programmed to the nonvolatile memory device 140, the controller 130 ends the reprogram operation.

If the error included in the last programmed data is uncorrectable, the procedure proceeds from step S330 to step S370. In step S370, the controller 130 receives the last programmed data from the host device 110 (see FIG. 1). In step S380, the controller 130 programs the received data to the nonvolatile memory device 140. When the received data is programmed to the nonvolatile memory device 140, the controller 130 ends the reprogram operation.

According to the method of FIG. 7, if a correctable number of errors are included in last programmed data, the reprogram operation may be selectively performed according to the number of error bits. As a consequence, the number of times by which the reprogram operation is performed to remove errors may be decreased.

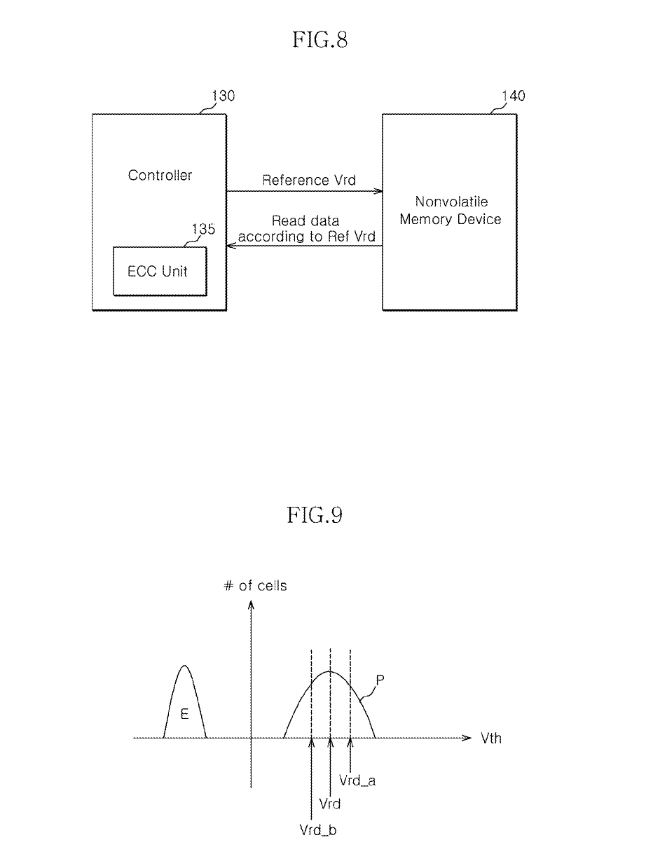

FIG. 8 is a block diagram explaining a control relationship between a controller and a memory device of the data storage device in accordance with some embodiments. Referring to FIG. 8, a controller 130 is configured to control read, write (or program) and erase operations of a nonvolatile memory device 140. In particular, the controller 130 may provide a read voltage Vrd to be used in the read operation of the nonvolatile memory device 140, to the nonvolatile memory device 140. In order to provide the read voltage Vrd to the nonvolatile memory device 140, the controller 130 may use a specified command or a specified control signal. If the read voltage Vrd is provided by the controller 130, the nonvolatile memory device 140 may perform the read operation according to the provided read voltage Vrd. Further, the nonvolatile memory device 140 may provide the data read according to the provided read voltage Vrd, to the controller 130.

FIG. 9 is a graph explaining the number of error bits according to a read voltage level of the memory device in accordance with some embodiments. Referring to FIG. 9, if a read operation is performed according to a read voltage Vrd_a greater than a reference or normal read voltage Vrd, since the number of failed memory cells increases, the number of error bits included in read data increases. Conversely, if a read operation is performed according to a read voltage Vrd_b less than the normal read voltage Vrd, since the number of failed memory cells decreases, the number of error bits included in read data decreases. Accordingly, the controller 130 (see FIG. 8) may influence the number of error bits included in read data, by providing a reference read voltage to the nonvolatile memory device 140 (see FIG. 8).

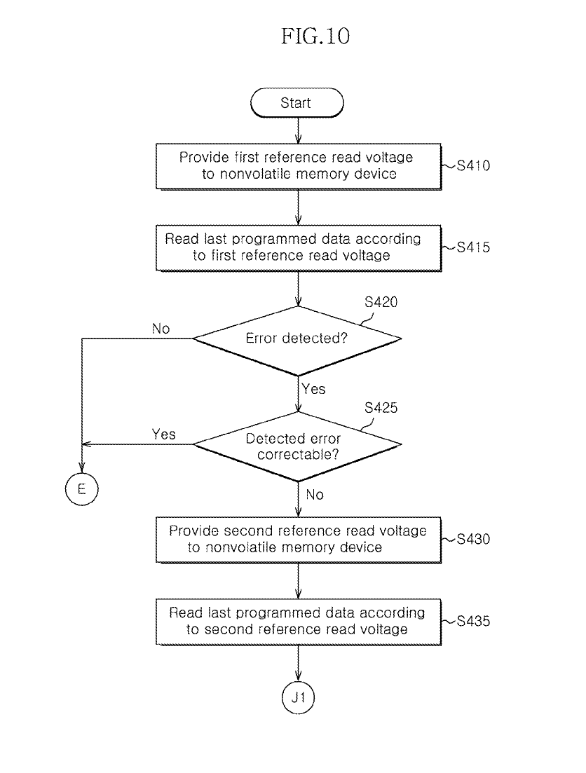

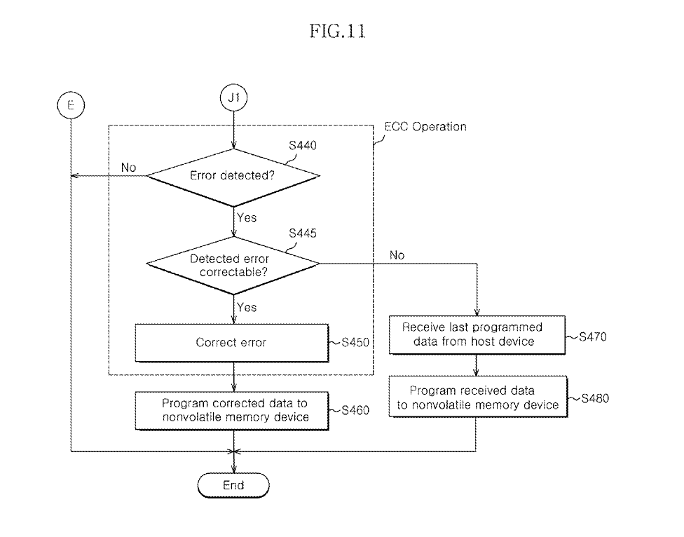

According to some embodiments, the controller 130 may read last programmed data according to a reference read voltage Vrd and may selectively perform a reprogram operation according to whether an ECC operation for the data read has failed or passed. Examples of such reprogram methods are described below with reference to FIGS. 10 and 11 and FIGS. 12 and 13.

FIGS. 10 and 11 illustrate a flow chart explaining a method of operating a data storage device in accordance with a fourth embodiment. In FIGS. 10 and 11, a series of operations are shown. The operations determine whether a detected error is correctable or not and correct correctable errors. The operations also replace data having uncorrectable errors. As discussed above, last programmed data is read according to a reference read voltage Vrd, and reprogram operations are performed in the case where the ECC operation for the read data has failed and, in some embodiments, in the case where the ECC operation has passed.

In step S410, during a booting operation, the controller 130 (see FIG. 1) provides a first reference read voltage to the nonvolatile memory device 140 (see FIG. 1). In step S415, the controller 130 reads the last or most recently programmed data according to the first reference read voltage.

In step S420, the ECC unit 135 (see FIG. 1) detects whether the read most recently programmed data includes an error. For example, an error detecting operation of the ECC unit 135 may be performed using parity data. If no error is detected in the last programmed data, the procedure ends. Conversely, if an error is detected in the last programmed data, the procedure proceeds to step S425.

In step S425, the ECC unit 135 determines whether the error included in the data read according to the first reference read data, that is, the last programmed data, is correctable. If it is determined that the error included in the last programmed data is uncorrectable, the procedure proceeds to step S430.

Conversely, if it is determined that the error included in the last programmed data is correctable, the reprogram procedure ends. As described above with reference to FIG. 9, since the controller 130 reads the last programmed data according to the first reference read voltage, the number of error bits included in the read data may be influenced. If the error included in the read data is correctable even though the number of error bits of the read data was influenced, since the probability of an uncorrectable error occurring with the lapse of time (for example, with degradation of a retention characteristic) is small, the controller 130 ends the reprogram procedure.

In step S430, the controller 130 provides a second reference read voltage to the nonvolatile memory device 140. For instance, the second reference read voltage may have a lower voltage value than the first reference read voltage of step S410. In step S435, the controller 130 reads the last programmed data according to the second reference read voltage. That is to say, data is read in such a manner that the number of error bits included in the data read according to the second reference read voltage is less than the number of error bits included in the data read according to the first reference read voltage.

In step S440, the ECC unit 135 detects whether an error is in the data read according to the second reference read voltage, that is, the last programmed data. If no error is detected in the last programmed data, the procedure ends. Conversely, if an error is detected in the last programmed data, the procedure proceeds to step S445.

In step S445, the ECC unit 135 determines whether the error in the data read according to the second reference read data, that is, the last programmed data, is correctable. If the error included in the last programmed data is correctable, the procedure proceeds to step S450. Conversely, if the error included in the last programmed data is uncorrectable, the procedure proceeds to step S470.

In step S450, the ECC unit 135 corrects the error included in the data read according to an error correction algorithm.

In step S460, the controller 130 reprograms error-corrected data to the nonvolatile memory device 140. For instance, the error-corrected data may be reprogrammed to an area where it was originally stored (for example, an area where the last programmed data was stored). In some embodiments, the error-corrected data may be reprogrammed to an area different from the area where it was originally stored (for example, an area different from the area where the last programmed data was stored). In another example, while not shown in the drawing, as described above with reference to the method of FIG. 5, in the case where the last programmed data is upper bit data (MSB data), the controller 130 may read paired data (LSB data) and reprogram the paired data (LSB data) and the error-corrected data (MSB data) to the nonvolatile memory device 140. When the error-corrected data is programmed to the nonvolatile memory device 140, the controller 130 ends the reprogram operation.

If the error included in the data read according to the second reference read voltage, that is, the last programmed data, is uncorrectable, the procedure proceeds from step S445 to step S470. In step S470, the controller 130 receives the last programmed data from the host device 110 (see FIG. 1). In step S480, the controller 130 programs the received data to the nonvolatile memory device 140. When the received data is normally programmed to the nonvolatile memory device 140, the controller 130 ends the reprogram operation.

According to the reprogram method of a data storage device in accordance with the fourth embodiment, the controller 130 may read last programmed data according to a reference read voltage Vrd and may selectively perform a reprogram operation according to whether an ECC operation for the data read according to the provided reference read voltage Vrd has failed or passed.

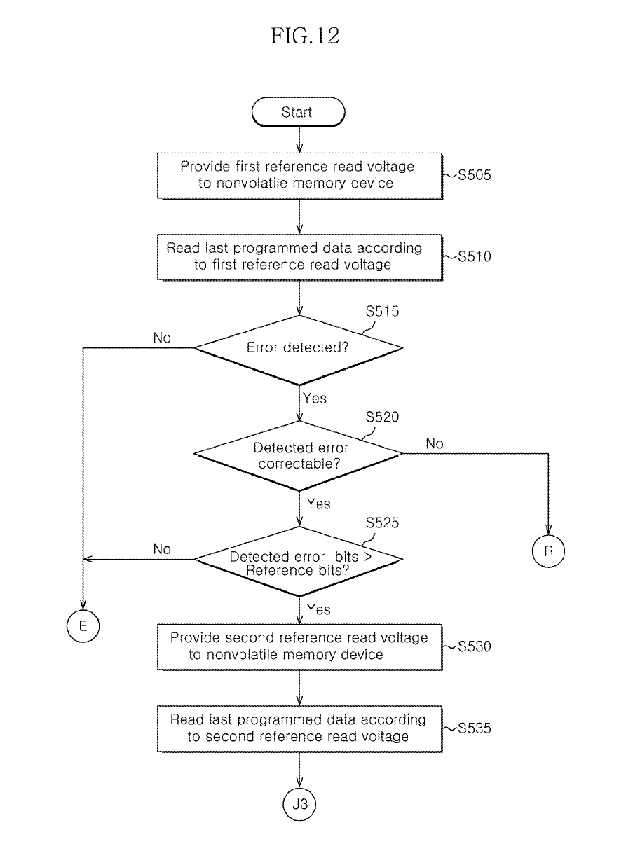

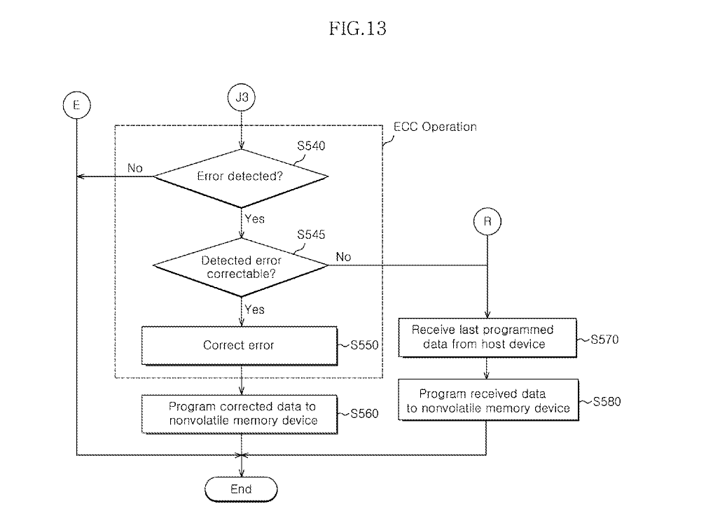

FIGS. 12 and 13 illustrate a flow chart explaining a method of operating a data storage device in accordance with another embodiment. In FIGS. 12 and 13, a series of operations are shown. The operations determine whether the detected error is correctable or not and correct correctable errors. The operations also replace data having uncorrectable errors. As discussed above, last programmed data is read according to a reference read voltage Vrd, and reprogram operations are respectively performed in the case where the ECC operation for the read data has failed and, in some embodiments, according to the number of error bits in the case where the ECC operation has passed.

In step S505, during a booting operation, the controller 130 (see FIG. 1) provides a first reference read voltage to the nonvolatile memory device 140 (see FIG. 1). In step S510, the controller 130 reads the last or most recently programmed data according to the first reference read voltage.

In step S515, the ECC unit 135 (see FIG. 1) detects whether the read most recently programmed data includes an error. For example, an error detecting operation of the ECC unit 135 is performed using parity data. If no error is detected in the last programmed data, the procedure ends. Conversely, if an error is detected in the last programmed data, the procedure proceeds to step S520.

In step S520, the ECC unit 135 determines whether the error included in the data read according to the first reference read data, that is, the last programmed data, is correctable. If the error included in the last programmed data is correctable, the procedure proceeds to step S525. Conversely, if the error included in the last programmed data is uncorrectable, the procedure proceeds to step S570.

In step S525, the ECC unit 135 determines whether the number of error bits included in the data read according to the first reference read voltage, that is, the last programmed data, is greater than a reference value. The reference value has a value less than a maximum number of correctable error bits. According to whether the number of error bits included in the read data is greater than a reference value, the reprogram operation is selectively performed.

For example, if the number of error bits included in the data read according to the first reference read voltage, that is, the last programmed data, is less than the reference value, since the probability of an uncorrectable error occurring with the lapse of time (for example, with degradation of a retention characteristic) is small, the reprogram procedure ends. Conversely, if the number of error bits included in the last programmed data is larger than the reference value, as described above with reference to FIG. 9, a read operation for influencing the number of error bits included in read data is performed. The procedure proceeds to step S530.

In step S530, the controller 130 provides a second reference read voltage to the nonvolatile memory device 140. For instance, the second reference read voltage may have a lower voltage value than the first reference read voltage of step S505. In step S535, the controller 130 reads the last programmed data according to the second reference read voltage. That is to say, data is read and the number of error bits included in the data read according to the second reference read voltage is less than the number of error bits included in the data read according to the first reference read voltage.

In step S540, the ECC unit 135 detects whether an error is included in the data read according to the second reference read voltage, that is, the last programmed data. If no error is detected in the last programmed data, the procedure ends. Conversely, if an error is detected in the last programmed data, the procedure proceeds to step S545.

In step S545, the ECC unit 135 determines whether the error included in the data read according to the second reference read data, that is, the last programmed data, is correctable. If the error is correctable, the procedure proceeds to step S550. Conversely, if the error is uncorrectable, the procedure proceeds to step S570.

In step S550, the ECC unit 135 corrects the error included in the data read according to an error correction algorithm.

In step S560, the controller 130 reprograms error-corrected data to the nonvolatile memory device 140. For instance, the error-corrected data may be reprogrammed to an area where it was originally stored (for example, an area where the last programmed data was stored). In some embodiments, the error-corrected data may be reprogrammed to an area different from the area where it was originally stored (for example, an area different from the area where the last programmed data was stored). In another example, while not shown in the drawing, as described above with reference to the method of FIG. 5, in the case where the last programmed data is upper bit data (MSB data), the controller 130 may read paired data (LSB data) and reprogram the paired data (LSB data) and the error-corrected data (MSB data) to the nonvolatile memory device 140. When the error-corrected data is programmed to the nonvolatile memory device 140, the controller 130 ends the reprogram operation.

If the error included in the data read according to the second reference read voltage, that is, the last programmed data, is uncorrectable, the procedure proceeds from step S545 to step S570. In step S570, the controller 130 receives the last programmed data from the host device 110 (see FIG. 1). In step S580, the controller 130 programs the received data to the nonvolatile memory device 140. When the received data is normally programmed to the nonvolatile memory device 140, the controller 130 ends the reprogram operation.

According to some embodiments of methods of reprogramming a data storage device, the controller 130 may read last programmed data according to a reference read voltage Vrd and may selectively perform a reprogram operation according to the number of error bits in the read data in the case where an ECC operation for the data read has passed.

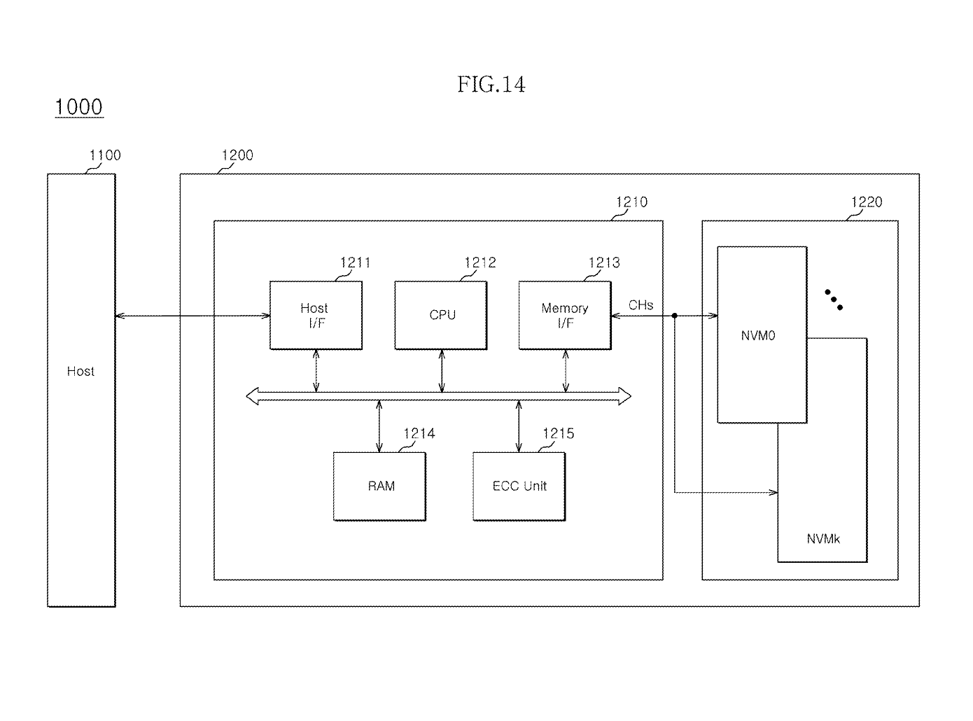

FIG. 14 is a block diagram exemplarily showing a data processing system in accordance with another embodiment. Referring to FIG. 14, a data processing system 1000 includes a host 1100 and a data storage device 1200. The data storage device 1200 includes a controller 1210 and a data storage medium 1220. The data storage device 1200 may be used by being connected to the host 1100 such as a desktop computer, a notebook computer, a digital camera, a mobile phone, an MP3 player, a game machine, and the like. The data storage device 1200 is also referred to as a memory system.

The reprogram method in accordance with the embodiments may be performed for the data storage device 1200. Accordingly, the reliability of the data storage device 1200 may be improved.

The controller 1210 is connected to the host 1100 and the data storage medium 1220. The controller 1210 is configured to access the data storage medium 1220 in response to a request from the host 1100. For example, the controller 1210 is configured to control the read, program or erase operation of the data storage medium 1220. The controller 1210 is configured to drive a firmware for controlling the data storage medium 1220.

The controller 1210 may include well-known components such as a host interface 1211, a central processing unit 1212, a memory interface 1213, a RAM 1214, and an error correction code unit 1215.

The central processing unit 1212 is configured to control the general operations of the controller 1210 in response to a request from the host 1100. The RAM 1214 may be used as a working memory of the central processing unit 1212. The RAM 1214 may temporarily store the data read from the data storage medium 1220 or the data provided from the host 1100.

The host interface 1211 is configured to interface the host 1100 and the controller 1210. For example, the host interface 1211 may be configured to communicate with the host 1100 through one of various interface protocols such as a USB (universal serial bus) protocol, an MMC (multimedia card) protocol, a PCI (peripheral component interconnection) protocol, a PCI-E (PCI-express) protocol, a PATA (parallel advanced technology attachment) protocol, a SATA (serial ATA) protocol, an SCSI (small computer system interface) protocol, an SAS (serial attached SCSI) protocol, and an IDE (integrated drive electronics) protocol.

The memory interface 1213 is configured to interface the controller 1210 and the data storage medium 1220. The memory interface 1213 is configured to provide a command and an address to the data storage medium 1220. Furthermore, the memory interface 1213 is configured to exchange data with the data storage medium 1220.

The error correction code unit 1215 is configured to detect an error of the data read from the data storage medium 1220. Also, the error correction code unit 1215 is configured to correct the detected error when the detected error falls within a correction range. Meanwhile, the error correction code unit 1215 may be provided inside or outside the controller 1210 depending on the memory system 1000.

The controller 1210 and the data storage medium 1220 may be configured as a solid state drive (SSD).

As another example, the controller 1210 and the data storage medium 1220 may be integrated into one semiconductor apparatus and may be configured as a memory card. For example, the controller 1210 and the data storage medium 1220 may be integrated into one semiconductor apparatus and may be configured as a PCMCIA (personal computer memory card international association) card, a CF (compact flash) card, a smart media card, a memory stick, a multimedia card (MMC, RS-MMC and MMC-micro), an SD (secure digital) card (SD, Mini-SD and Micro-SD), a UFS (universal flash storage), etc.

In another example, the controller 1210 or the data storage medium 1220 may be mounted in various types of packages. For example, the controller 1210 or the data storage medium 1220 may be mounted by being packaged into packages such as a POP (package on package), a ball grid array (BGA) package, a chip scale package (CSP), a plastic leaded chip carrier (PLCC), a plastic dual in-line package (PDIP), a die in waffle pack, a die in wafer form, a chip on board (COB), a ceramic dual in-line package (CERDIP), a plastic metric quad flat package (MQFP), a thin quad flat package (TQFP), a small outline IC (SOIC), a shrink small outline package (SSOP), a thin small outline package (TSOP), a thin quad flat package (TQFP), a system in package (SIP), a multi-chip package (MCP), a wafer-level fabricated package (WFP), and a wafer-level processed stack package (WSP).

FIG. 15 is a diagram exemplarily showing a memory card in accordance with an embodiment. FIG. 15 shows the outer appearance of an SD (secure digital) card among memory cards.

Referring to FIG. 15, the SD card includes one command pin (for example, a second pin), one clock pin (for example, a fifth pin), four data pins (for example, first, seventh, eighth and ninth pins), and three power pins (for example, third, fourth and sixth pins).

Through the command pin (the second pin), a command and a response signal are transmitted. In general, the command is transmitted to the SD card from a host, and the response signal is transmitted to the host from the SD card.

The data pins (the first, seventh, eighth and ninth pins) are divided into reception (Rx) pins for receiving data transmitted from the host and transmission (Tx) pins for transmitting data to the host. The reception (Rx) pins and the transmission (Tx) pins are provided in pairs to transmit differential signals.

The reprogram method in accordance with the embodiments may be performed for the SD card. Accordingly, the reliability of the SD card may be improved.

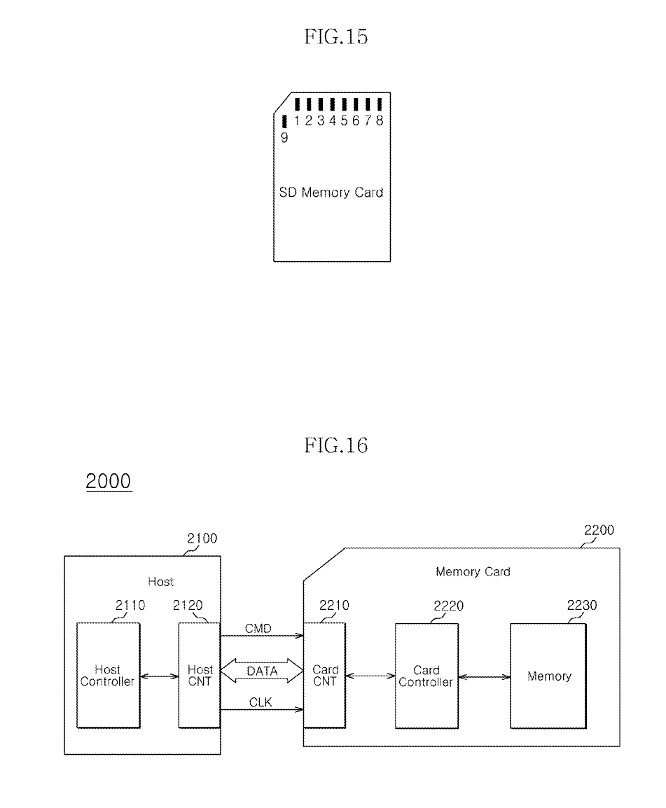

FIG. 16 is a block diagram showing the internal configuration of the memory card shown in FIG. 15 and the connection relationship between the memory card and a host. Referring to FIG. 16, a data processing system 2000 includes a host 2100 and a memory card 2200. The host 2100 includes a host controller 2110 and a host connection unit 2120. The memory card 2200 includes a card connection unit 2210, a card controller 2220, and a memory device 2230.

The host connection unit 2120 and the card connection unit 2210 include a plurality of pins. The pins may include a command pin, a clock pin, a data pin, and a power pin. The number of pins changes depending on the kind of the memory card 2200.

The host 2100 stores data in the memory card 2200 or reads data stored in the memory card 2200.

The host controller 2110 transmits a write command CMD, a clock signal CLK generated from a clock generator (not shown) in the host 2100, and data DATA to the memory card 2200 through the host connection unit 2120. The card controller 2220 operates in response to the write command received through the card connection unit 2210. The card controller 2220 stores the received data DATA in the memory device 2230, using a clock signal generated from a clock generator (not shown) in the card controller 2220, according to the received clock signal CLK.

The host controller 2110 transmits a read command CMD and a clock signal CLK generated from a clock generator (not shown) in the host 2100 to the memory card 2200 through the host connection unit 2120. The card controller 2220 operates in response to the read command received through the card connection unit 2210. The card controller 2220 reads data from the memory device 2230 using a clock signal generated from a clock generator (not shown) in the card controller 2220, according to the received clock signal CLK, and transmits the read data to the host controller 2110.

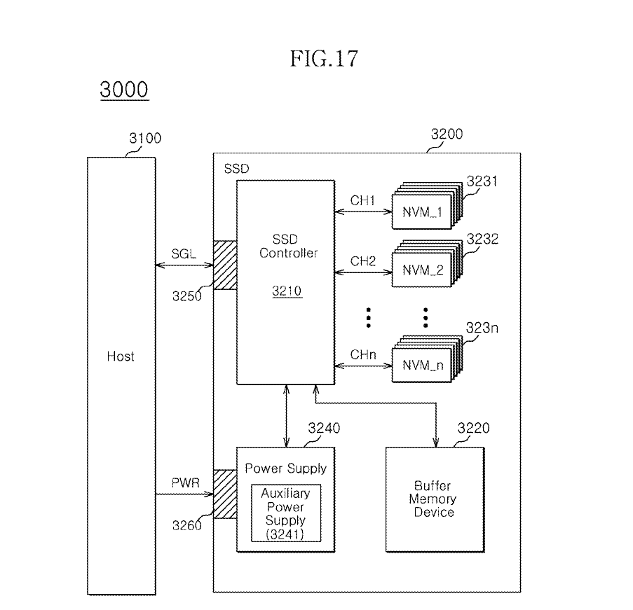

FIG. 17 is a block diagram showing an SSD in accordance with an embodiment of the present invention. Referring to FIG. 17, a data processing system 3000 includes a host 3100 and an SSD 3200.

The SSD 3200 includes an SSD controller 3210, a buffer memory device 3220, nonvolatile memory devices 3231 to 323n, a power supply 3240, a signal connector 3250, and a power connector 3260.

The SSD 3200 operates in response to a request from the host 3100. That is to say, the SSD controller 3210 is configured to access the nonvolatile memory devices 3231 to 323n in response to a request from the host 3100. For example, the SSD controller 3210 is configured to control read, program and erase operations of the nonvolatile memory devices 3231 to 323n. Further, the reprogram method in accordance with the embodiments may be performed for the SDD controller 3210. Accordingly, the reliability of the SSD 3200 may be improved.

The buffer memory device 3220 is configured to temporarily store data which are to be stored in the nonvolatile memory devices 3231 to 323n. Further, the buffer memory device 3220 is configured to temporarily store data which are read from the nonvolatile memory devices 3231 to 323n. The data temporarily stored in the buffer memory device 3220 are transmitted to the host 3100 or the nonvolatile memory devices 3231 to 323n under the control of the SSD controller 3210.

The nonvolatile memory devices 3231 to 323n are used as storage media of the SSD 3200. The nonvolatile memory devices 3231 to 323n are connected to the SSD controller 3210 through a plurality of channels CH1 to CHn, respectively. One or more nonvolatile memory devices may be connected to one channel. The nonvolatile memory devices connected to one channel are connected to the same signal bus and data bus.

The power supply 3240 is configured to provide power PWR inputted through the power connector 3260 to the inside of the SSD 3200. The power supply 3240 includes an auxiliary power supply 3241. The auxiliary power supply 3241 is configured to supply power so as to allow the SSD 3200 to be normally terminated when sudden power-off occurs. The auxiliary power supply 3241 may include super capacitors capable of being charged with power PWR.

The SSD controller 3210 exchanges a signal SGL with the host 3100 through the signal connector 3250. Here, the signal SGL includes a command, an address, data, and the like. The signal connector 3250 may by constituted by a connector such as PATA (parallel advanced technology attachment), SATA (aerial advanced technology attachment), SCSI (small computer system interface), SAS (serial SCSI), and the like, according to an interface scheme between the host 3100 and the SSD 3200.

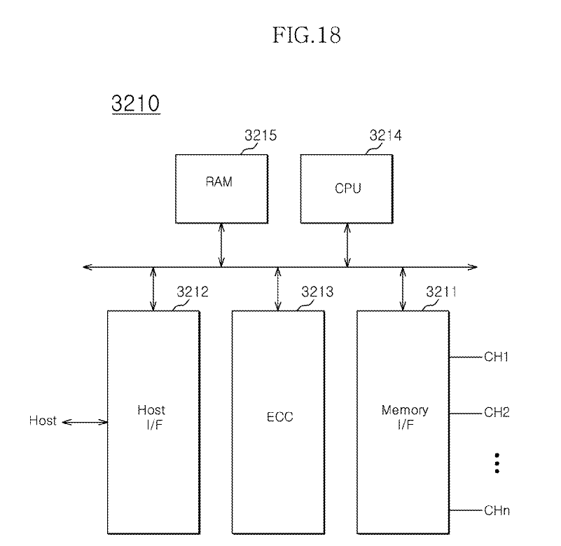

FIG. 18 is a block diagram exemplarily showing the SSD controller shown in FIG. 17. Referring to FIG. 18, the SSD controller 3210 includes a memory interface 3211, a host interface 3212, an ECC unit 3213, a central processing unit 3214, and a RAM 3215.

The memory interface 3211 is configured to provide a command and an address to the nonvolatile memory devices 3231 to 323n. Moreover, the memory interface 3211 is configured to exchange data with the nonvolatile memory devices 3231 to 323n. The memory interface 3211 may scatter data transmitted from the buffer memory device 3220 to the respective channels CH1 to CHn, under the control of the central processing unit 3214. Furthermore, the memory interface 3211 transmits data read from the nonvolatile memory devices 3231 to 323n to the buffer memory device 3220, under the control of the central processing unit 3214.

The host interface 3212 is configured to provide an interface with the SSD 3200 in correspondence to the protocol of the host 3100. For example, the host interface 3212 may be configured to communicate with the host 3100 through one of PATA (parallel advanced technology attachment), SATA (serial advanced technology attachment), SCSI (small computer system interface) and SAS (serial SCSI) protocols. In addition, the host interface 3212 may perform a disk emulation function of supporting the host 3100 to recognize the SSD 3200 as a hard disk drive (HDD).

The ECC unit 3213 is configured to generate parity bits based on the data transmitted to the nonvolatile memory devices 3231 to 323n. The generated parity bits may be stored in spare areas of the nonvolatile memory devices 3231 to 323n. The ECC unit 3213 is configured to detect an error of data read from the nonvolatile memory devices 3231 to 323n. When the detected error falls within a correction range, the ECC unit 3213 is configured to correct the detected error.

The central processing unit 3214 is configured to analyze and process a signal SGL inputted from the host 3100. The central processing unit 3214 controls general operations of the SSD controller 3210 in response to a request from the host 3100. The central processing unit 3214 controls the operations of the buffer memory device 3220 and the nonvolatile memory devices 3231 to 323n according to a firmware for driving the SSD 3200. The RAM 3215 is used as a working memory device for driving the firmware.

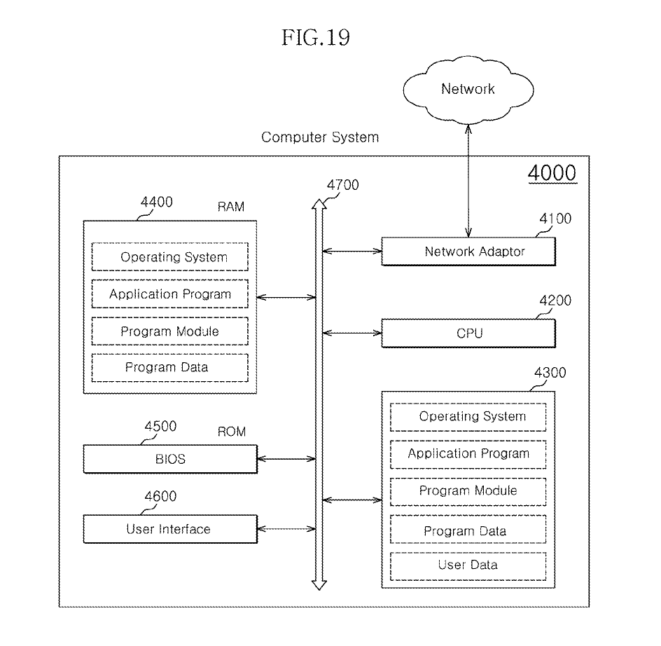

FIG. 19 is a block diagram exemplarily showing a computer system in which a data storage device in accordance with an embodiment of the present invention is mounted. Referring to FIG. 19, a computer system 4000 includes a network adaptor 4100, a central processing unit 4200, a data storage device 4300, a RAM 4400, a ROM 4500 and a user interface, which are electrically connected to a system bus 4700. The data storage device 4300 may be constituted by the data storage device 120 shown in FIG. 1, the data storage device 1200 shown in FIG. 14 or the SSD 3200 shown in FIG. 17.

The network adaptor 4100 provides interfacing between the computer system 4000 and external networks. The central processing unit 4200 performs general operation processing for driving an operating system residing at the RAM 4400 or an application program.

The data storage device 4300 stores general data necessary in the computer system 4000. For example, an operating system for driving the computer system 4000, an application program, various program modules, program data and user data are stored in the data storage device 4300.

The RAM 4400 may be used as a working memory device of the computer system 4000. Upon booting, the operating system, the application program, the various program modules and the program data necessary for driving programs, which are read from the data storage device 4300, are loaded on the RAM 4400. A BIOS (basic input/output system) which is activated before the operating system is driven is stored in the ROM 4500. Information exchange between the computer system 4000 and a user is implemented through the user interface 4600.

Although not shown in a drawing, it is to be readily understood that the computer system 4000 may further include devices such as an application chipset, a camera image processor (CIS), and the like.

As is apparent from the above descriptions, according to the embodiments the reliability of a data storage device may be improved.

While the present invention has been particularly shown and described with reference to exemplary embodiments thereof, it will be understood by those of ordinary skill in the art that various changes in form and details may be made therein without departing from the spirit and scope of the present invention.

What is claimed is:

1. A method of operating a data storage device including a nonvolatile memory device, the method comprising:
reading last programmed data from the nonvolatile memory device;
detecting an error in the read data;
determining whether the error is correctable;
correcting the error in the read data to generate corrected data if the error detected from the read data is correctable; and
reprogramming the corrected data to the nonvolatile memory device.

2. The operating method according to claim 1, further comprising:
re-receiving the last programmed data from a host device if the error detected from the read data is uncorrectable; and
reprogramming the re-received data to the nonvolatile memory device.

3. The operating method according to claim 1, wherein the last programmed data includes an error caused by a sudden power-off.

4. The operating method according to claim 1, wherein the reading of the last programmed data from the nonvolatile memory device is performed during a booting operation of the data storage device.

5. The operating method according to claim 1, wherein the corrected data is reprogrammed to an area where the read data was stored.

6. The operating method according to claim 1, wherein the corrected data is reprogrammed to an area different from the area where the read data was stored.

7. The operating method according to claim 1, wherein the nonvolatile memory device includes multi-level cells each capable of storing 2 or more-bit data, and the read data is upper bit data, the method further comprises:
reading data paired with the upper bit data from the nonvolatile memory device.

8. The operating method according to claim 7, wherein the reprogramming concurrently programs the paired data and the corrected data to the nonvolatile memory device.

9. A method of operating a data storage device including a nonvolatile memory device, the method comprising:
reading last programmed data from the nonvolatile memory device according to a first reference read voltage;
detecting a first error in the data read according to the first reference read voltage;
determining whether the first error is uncorrectable;
reading the last programmed data from the nonvolatile memory device according to a second reference read voltage if the first error is uncorrectable;
detecting a second error in the data read according to the second reference read voltage;
determining whether the second error is correctable;
correcting the second error to generate corrected data if the second error is correctable; and
reprogramming the corrected data to the nonvolatile memory device.

10. The operating method according to claim 9, further comprising:
re-receiving the last programmed data from a host device if the second error is uncorrectable; and
reprogramming the re-received data to the nonvolatile memory device.

11. The operating method according to claim 9, wherein the second reference read voltage is less than the first reference read voltage.

12. The operating method according to claim 9, wherein the corrected data is reprogrammed to an area where the last programmed data was stored.

13. The operating method according to claim 9, wherein the corrected data is reprogrammed to an area different from the area where the last programmed data was stored.

14. The operating method according to claim 9, wherein the nonvolatile memory device includes multi-level cells each capable of storing 2 or more-bit data, and the last programmed data is upper bit data, the method further comprising:
reading data paired with the upper bit data from the nonvolatile memory device.

15. The operating method according to claim 14, wherein the reprogramming concurrently programs the paired data and the corrected data to the nonvolatile memory device.

16. The operating method according to claim 9, wherein the reading of the last programmed data from the nonvolatile memory device according to the first reference read voltage is performed during a booting operation of the data storage device.

17. A method of operating a data storage device including a nonvolatile memory device, the method comprising:
reading last programmed data from the nonvolatile memory device according to a first reference read voltage;
detecting a first error in the data read according to the first reference read voltage;
determining whether the first error is correctable;
comparing the number of error bits of the data read according to the first reference read voltage with a reference number of bits, if the first error is correctable;
correcting the first error to generate corrected data if the number of error bits of the data read according to the first reference read voltage is greater than the reference number of bits; and
reprogramming the corrected data to the nonvolatile memory device.

18. The operating method according to claim 17, further comprising:
re-receiving the last programmed data from a host device if the first error is uncorrectable; and
reprogramming the re-received data to the nonvolatile memory device.

19. The operating method according to claim 17, wherein the reference number of bits is less than a maximum number of correctable error bits.

20. The operating method according to claim 17, wherein the corrected data is reprogrammed to an area where the last programmed data was stored.

21. The operating method according to claim 17, wherein the corrected data is reprogrammed to an area different from the area where the last programmed data was stored.

22. The operating method according to claim 17, wherein the nonvolatile memory device includes multi-level cells each capable of storing 2 or more-bit data, and the last programmed data is upper bit data, the method further comprising:
reading data paired with the upper bit data from the nonvolatile memory device.

23. The operating method according to claim 22, wherein the reprogramming concurrently programs the paired data and the corrected data to the nonvolatile memory device.

24. The operating method according to claim 17, wherein the reading of the last programmed data from the nonvolatile memory device according to the first reference read voltage is performed during a booting operation of the data storage device.
